(19) United States
(12) Patent Application Publication
(10) Pub. No.: US 2009/0023545 A1
(43) Pub. Date: Jan. 22, 2009

(54) STEADY-STATE AND TRANSITORY CONTROL FOR TRANSMISSION BETWEEN ENGINE AND ELECTRICAL POWER GENERATOR

(76) Inventor: Samuel Beaudoin, Mont-Saint-Hilaire (CA)

Correspondence Address: LADAS & PARRY LLP, 224 SOUTH MICHIGAN AVENUE, SUITE 1600, CHICAGO, IL, 60604, US

(21) Appl. No.: 11/576,080

(22) PCT Filed: Sep. 27, 2005
(86) PCT No.: PCT/CA05/01479

§ 371 Date: Aug. 6, 2007

(30) Foreign Application Priority Data
Sep. 27, 2004 (CA) 2479890

(51) Int. Cl. F16H 15/38; G06F 17/00; F16H 59/36; H02P 9/06

(52) U.S. Cl. 476/42; 701/61; 476/40; 290/40 C

(57) ABSTRACT

A system (1) for transforming a variable output into an input having a desired speed value, including a transmission (30) receiving the output having a first speed (Ve) and producing the input having a second speed (Vgen), first, second and third sensors (12,10,7) producing data (39,32,37) corresponding to the first speed (Ve), second speed (Vgen) and a power demand (Pdem) for the input, a ratio set point controller (34), a ratio controller (36) and a speed controller (4). The ratio set point controller (34) receives the data (39,32,37) and calculates an available power (Pav), a stability level of the system (S,U1,U2), a desired value for the first speed (Ve), and a desired value and rate of change for the transmission ratio. The ratio controller (36) interfaces the ratio set point controller (34) and actuates the transmission (30) to change the transmission ratio to the desired value following the desired rate of change. The speed controller (4) changes the first speed (Ve) until the second speed (Vgen) corresponds to the desired speed value.

### CROSS-REFERENCE TO RELATED APPLICATION

The present patent application claims priority on Canadian Patent Application No. 2,479,890, filed on Sep. 27, 2004.

### FIELD OF THE INVENTION

The present invention generally relates to mechanical transmission systems and engine driven electrical power generator systems. More specifically, the present invention is concerned with a continuously variable transmission system that can be advantageously used in a power generator system to provide constant speed drive of a generator to supply regulated power to a variable load, while enabling continuous modulation of engine speed for operation in an optimal efficiency range.

### BACKGROUND ART

Generator systems have been used for years to supply electrical power to a load from a source of mechanical energy, such as a power take-off (PTO) of an internal combustion engine, driving a permanent magnet generator. Since the load must generally be supplied with alternating current power at a substantially constant frequency (typically 50 or 60 Hz), the generator should then be driven at a fairly constant rotary speed (1800 r.p.m. for 60 Hz and 1500 r.p.m. for 50 Hz with a two pole generator). Otherwise an electronic frequency converter must be inserted between the generator and the load to regulate the electrical wave frequency (see for example U.S. Pat. No. 5,552,640 (Sutton et al.—Sep. 3, 1996—British Gas plc). In view of eliminating the frequency converted, most generator systems therefore operate with diesel engines driven at constant speed, in a substantially high range to provide for the full generator rated power capacity at all time.

As emphasized by Sutton, operating the engine at constant speed has numerous disadvantages, which can be obviated by introducing an appropriate engine speed controller. Indeed, it is well known by one of ordinary skill in the art that an internal combustion engine should deliver a given power at a specific speed for optimal efficiency (output mechanical power/input fuel power). Hence, operating the engine at constant speed when load demand varies significantly yields higher fuel costs, increased emission of pollutants, higher noise level, and higher maintenance costs. It is therefore desirable to continuously adjust the engine speed as a function of the instant power demand at the load. Amongst numerous advantageous characteristics of such a system, full engine power may be available at the upper speed range to support heavy loads, while light loading may enable running the engine near idle level. This, however, raises the problem of continuously converting the variable speed of the engine into a constant speed drive to operate the generator at a steady frequency through a fixed ratio gearbox.

Cronin, in U.S. Pat. No. 4,382,188 (Lockheed Corp.—May 3, 1983) teaches that a continuously variable transmission (CVT) such as a toroidal drive may be used to enable a variable speed mechanical output from an engine to be converted to drive a permanent magnet generator at constant frequency, over a preselected engine speed range. Indeed, in a CVT, the ratio of the output speed of the drive from the transmission to the input speed of the drive applied to the transmission is continuously and infinitely variable between predetermined high and low ratio limits. However, Cronin's invention is meant to react to an intrinsically variable engine speed and has no view (scheme) of controlling said engine for efficiency purposes. In U.S. Pat. No. 5,539,258 (Sutton et al.—Jul. 23, 1996—British Gas plc) and in the European Patent No. 0 643 474 (Sutton—Mar. 3, 1997—British Gas plc), though, Sutton discloses a specific engine driven power generator system comprising a toroidal CVT and a computerized system to control the engine throttle and the continuous transmission ratio, so that when a change is detected in the load power demand, the engine speed is automatically set in the most efficient range corresponding to the measured power demand, based on a programmed engine efficiency map.

Although such a system may operate properly with slowly changing load power demand, it remains a substantial challenge to preserve the quality of the supplied current when sudden changes of load demand are experienced. This, is mainly due to transients responsive to inertia and delays in the system. For example, the engine requires some rise time to accelerate to full speed when a load is suddenly applied and the throttle is fully opened. Reciprocally, the engine must not race when the load is being suddenly disconnected from the generator, and the engine and CVT must remain in stable mode at all time in spite of any variation of the power demand. Many engine/CVT systems have been developed which can perform satisfactorily in a vehicle, but none would complying with the requirements for an ac power generator destined to feed an electrical power network and run thousands of hours per year. It is also worth mentioning that most continuously variable transmissions and engine control devices have been developed for vehicles such as cars, boats, trains and planes. Therefore, most of them rely on hydraulic power or hydraulic devices for operation, and the affordable types are not built to sustain so many hours of cycling yearly. While hydraulics is a natural option for vehicles, costs for low production volumes and maintenance requirements make it undesirable for use in heavy duty power generators. Therefore, fully mechanical toroidal CVT's such as described in U.S. Pat. No. 3,581,587 (Dickenbrock—Jun. 1, 1971—General Motors Corp.) is contemplated as the type of CVT to be preferred for such an application. In a toroidal CVT, mechanical power is transmitted from an input toroidal disk to an output toroidal disk through a series of friction rollers running on the inner face of each disk at a controllable distance from the center thereof. Ratio is controlled by forcing the rollers to run on tracks of different diameters on each disk, the ratio of the diameters defining the transmission ratio. This fairly simple basic concept is well adapted to generator systems. However, improvements must be implemented into the earlier designs in order to make them reliable, tough and flexible enough to suit this demanding application.

Although the above examples show that some power generator systems of the prior art contemplated the use of a continuously variable transmission to enable variation of the engine speed to improve efficiency, these systems and transmission devices are nevertheless lacking important features necessary for them to provide practical, reliable and rugged, yet affordable solutions for the supply of stable electrical power, in frequency and voltage, to a variable load.

It would therefore be a significant advance in the art of power generation systems and mechanical transmission systems, to provide a transmission system enabling constant speed drive of an apparatus from a variable speed mechanical energy source, and a high efficiency generator system featuring engine speed modulation which can be advantageously used to supply a variable load with stable electrical power.

### SUMMARY OF INVENTION

An object of the present invention is therefore to provide a high efficiency generator system and a continuously variable transmission therefor, obviating the limitations and drawbacks of the prior art devices and systems.

More specifically, in accordance with the present invention, there is provided a system for transmitting a variable output of a variable source of mechanical power into an input having a desired apparatus speed value for an apparatus, the system comprising: a transmission receiving the variable output and producing the input, the transmission defining a transmission ratio between a first speed of the output and a second speed of the input; a first sensor measuring the first speed and producing first speed data corresponding thereto; a second sensor measuring the second speed and producing second speed data corresponding thereto; a third sensor measuring a power demand of the apparatus and producing power demand data corresponding thereto; a ratio set point controller receiving the first and second speed data and the power demand data, the ratio set point controller calculating an available power of the source and a stability level of the system as a function of the first speed data and the power demand data, determining a desired source speed value for the first speed as a function of the power demand, calculating a desired ratio value for the transmission ratio as a function of the desired source speed value, and determining a desired rate of change for the transmission ratio as a function of the stability level of the system; a ratio controller interfacing the ratio set point controller to the transmission, the ratio controller actuating the transmission to change the transmission ratio to the desired ratio value following the desired rate of change; and a source speed controller receiving the second speed data from the second sensor and changing the first speed until the second speed data corresponds to the desired apparatus speed value.

Also in accordance with the present invention, there is provided a system for transforming a variable output of a variable source of mechanical power into an input having a desired speed value for an apparatus, the system comprising: a transmission receiving the variable output and producing the input, the transmission having a variable ratio between a first speed of the output and a second speed of the input; at least one sensor producing first speed data corresponding to the first speed, second speed data corresponding to the second speed, and power demand data corresponding to a power demand of the apparatus; a first controller receiving the first speed data, the second speed data and the power demand data, calculating an available power and a desired transmission ratio value based on the first speed data and the power demand data, classifying the system in one of at least first and second categories based on a first comparison of the first speed with a set range including the desired speed value and a second comparison of the available power with at least one threshold value, instructing the transmission to bring the variable ratio to the desired transmission ratio value rapidly when the system is in the first category, and instructing the transmission to bring the variable ratio to the desired transmission value progressively when the system is in the second category; and a second controller receiving the second speed data and sending a speed correction signal to the source of mechanical power to change the first speed until the second speed data corresponds to the desired speed value.

Further in accordance with the present invention, there is provided a method for controlling a variable transmission transforming a variable output of a variable source of mechanical power into an input having a desired speed value for an apparatus, the method comprising the steps of: obtaining a first speed of the variable output, a second speed of the input, and a power demand of the apparatus; calculating (1) an available power based on the first speed and the power demand, (2) a stability level of the input of the apparatus based on the first speed and the available power, (3) a desired ratio of the transmission based on the power demand, and (4) a desired rate of ratio change based on the stability level; instructing the transmission to change to the desired ratio at the desired rate of ratio change; and varying the first speed until the second speed is substantially equal to the desired speed value.

Still further in accordance with the present invention, there is provided a toroidal transmission comprising: first and second toroidal disks rotated by an input shaft; a third toroidal disk located between the first and second toroidal disk and rotating an output shaft; a plurality of first frictional rollers frictionally engaged to a toroidal cavity race of the first disk and a first toroidal cavity race of the third disk, each of the first frictional rollers being rotatable to transfer rotary power between the second and third disks; a plurality of second frictional rollers frictionally engaged to a toroidal cavity race of the second disk and a second toroidal cavity race of the third disk, each of the second frictional rollers being rotatable to transfer rotary power between the first and third disks; first means for retaining the first frictional rollers at a same first selective angle with respect to the third disk, the first means being actuable to change the first selective angle; second means for retaining the second frictional rollers at a same second selective angle with respect to the third disk, the second means being actuable to change the second selective angle; and third means for connecting the first and second means such that the first selective angle is substantially equal to the second selective angle and for actuating the first and second means together to obtain a selected value for the first and second selective angles, the selected value corresponding to at least one of a desired ratio of the transmission and a desired rate of ratio change of the transmission, the third means actuating the first and second means upon reception of a control signal.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is schematic representation of a high efficiency generator system according to an embodiment of the present invention;

FIG. 2 is a partial schematic representation of is the high efficiency generator system of FIG. 1, showing details of the engine controller;

FIG. 3 is a partial schematic representation of the high efficiency generator system of FIG. 1, showing details of the CVT controller;

FIG. 4 is a flow chart showing the operations performed by the CVT controller of FIG. 3;

FIG. 5 is a longitudinal cross-sectional view of a toroidal continuously variable transmission according to an embodiment of the present invention;

FIG. 6a is a radial cross-sectional view of a ratio control assembly of the transmission according to an embodiment of the present invention;

FIG. 6b is a cross-sectional view of the assembly of FIG. 6a taken from line BB;

FIG. 7a is a side view of the ratio control assembly of FIG. 6a showing actuating means thereof;

FIG. 7b is a partial top view of the actuating means of FIG. 7a;

FIG. 8a is a top view of one roller assembly of the transmission of FIG. 5 for a minimum underdrive ratio;

FIG. 8b is a top view of the assembly of FIG. 8a at a constant ratio of 1; and

FIG. 8c is a top view of the assembly of FIG. 8a for a maximum overdrive ratio.

Identical numerals in the drawings represent similar parts throughout the description.

### DESCRIPTION OF THE PREFERRED EMBODIMENTS

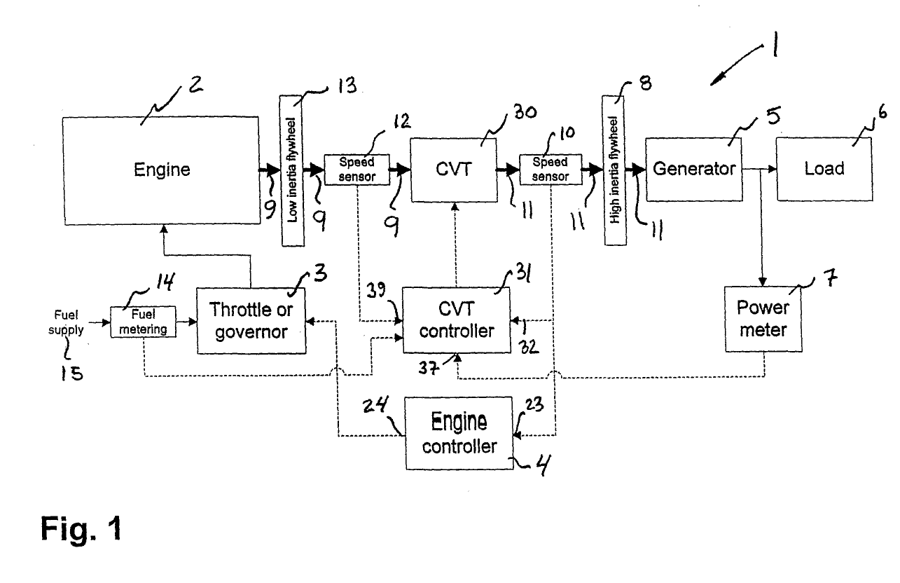

A continuously variable transmission system and a high efficiency generator system using same are generally identified by numeral 1, as illustrated in FIG. 1. The system described hereinafter will provide a stable output to an apparatus from a variable source of mechanical power through the use of a continuously variable transmission system provided with an appropriate controller. Furthermore, it is contemplated that the system provide a stable rated electrical output from a generator while performing engine speed modulation according to instant electrical power demand to improve energetic efficiency in a generator system.

The continuously variable transmission system comprises a CVT device 30 comprising an input drive shaft 9 for connection to the output of a mechanical power source such as internal combustion engine 2. An input speed sensor 12 is responsive to the rotation speed of shaft 9 and provides an input speed signal of the transmission 30 or an output speed signal of the engine 2 to CVT controller 31, a key component of the continuously variable transmission system. CVT controller 31 further comprises a load power signal input device 37 to monitor the power demand at the output of a driven apparatus such as 5. A low inertia flywheel 13 is fixedly mounted to input drive shaft 9 to provide some damping of rotation speed variations of the mechanical power source (engine) 2. It may be integrated to the power source itself as it is generally the case for engines, but its inertia should be minimized (lower than in usual power generation systems and more like in vehicle engines of comparable power) to permit rapid reaction of the source when necessary.

The continuously variable transmission system further comprises an output drive shaft 11 for connection to a constant speed rated apparatus such as the input rotor shaft of an electrical power generator 5, for supplying stable electrical power to load 6. Again, an output speed sensor 10 is responsive to the rotation speed of shaft 11 and provides an output speed signal of the transmission 30, or input speed signal of the generator 5, to CVT controller 31. A high inertia flywheel 8 is fixedly mounted to output drive shaft 11 to provide a mechanical energy buffer which prevents sudden change in output speed, due to rapid change in load power demand or engine speed and assist engine 2 in increasing its speed faster when necessary. The energy stored in large inertia output flywheel 8 must be much greater than that of the low inertia input flywheel 13 to ensure proper dynamic behavior of the system. This provision is a key factor for enabling proper management of the transient conditions to ensure a stable transmission output, especially when engine speed modulation is being carried-out, as for energetic efficiency optimization.

Changes in rotary speed of output drive shaft 11 change the input rotation speed of the rotor in 5 generator 5 which directly affects the frequency of the output electrical wave in the same proportion. Indeed, electrical output frequency is equal to the rotary speed (revolutions per second) times the number of poles (generally 2). For example, a two pole generator must be driven at exactly 1800 r.p.m. to produce a 60 Hz output wave. Output voltage may also be affected by fluctuations in rotary speed. Very limited variations of the electrical wave parameters can be tolerated from a generator system, especially when intended to supply an electrical network in case of power failure. Therefore, the system must be very stable and feature a high level of immunity to load demand fluctuations. This represents a real challenge while performing deliberate engine speed modulation according to energetic efficiency objectives.

In order to complete a functional high efficiency generator system, there is further provided an output power sensor (meter) 7 to supply a load power signal to the load power input device 37 of CVT controller 31. Furthermore, an engine controller 4 receives an output speed signal from output speed sensor 10 at input 23 and provides a speed control signal to throttle or governor 3 controlling the engine's speed, through output 24. Fuel supply 15 is supplied to throttle or governor 3, optionally through fuel metering device 1-4. It is pointed out that the engine speed control devices 3, 4, 15 are standard off-the-shelf items for generator systems.

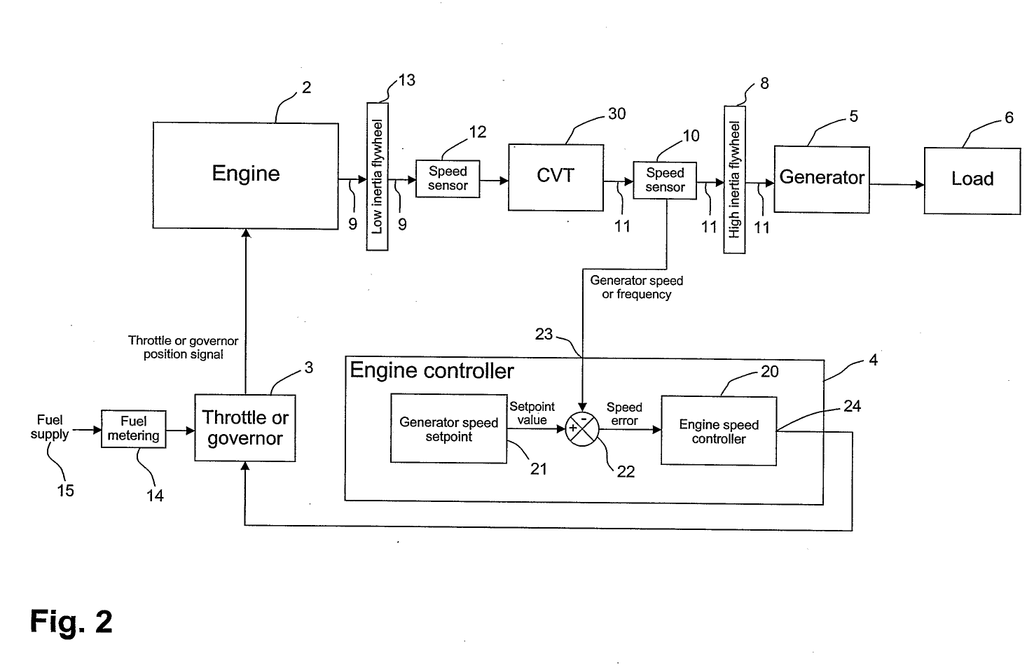

In a classical mode of operation, wherein engine speed is intended to remain stable and match the generator speed set point, the input 23 of the engine controller 4 is rather connected to a speed sensor such as 12 indicating the instant motor speed. Though, the typical speed controller 4 illustrated in more details in FIG. 2, most often merely compares the instant engine speed signal at input 23 to a generator speed set point signal 21 at comparator 22 which sends a speed error signal to engine speed controller 20, which in turn generates a control signal to actuate the throttle or governor 3 so to correct any deviation from the generator speed set point. In some cases of high-end engine controllers, the output power of the generator in also taken into account to improve performance. It is considered to use this type of engine controller with the system described herein.

In the present setup, the input 23 being connected to output speed sensor 10, monitoring the generator's rotary speed downstream from the CVT device 30, the standard engine controller 4 operates in the same manner, trying to maintain the generator's speed on the generator speed set point 21 (ex. 1800 r.p.m. for a 60 Hz electrical output), controlling the speed of engine 2 regardless of the behavior of CVT device 30. Therefore, all of the variable speed control required to provide the high efficiency generator system resides in the CVT controller 31 of the continuously variable transmission system.

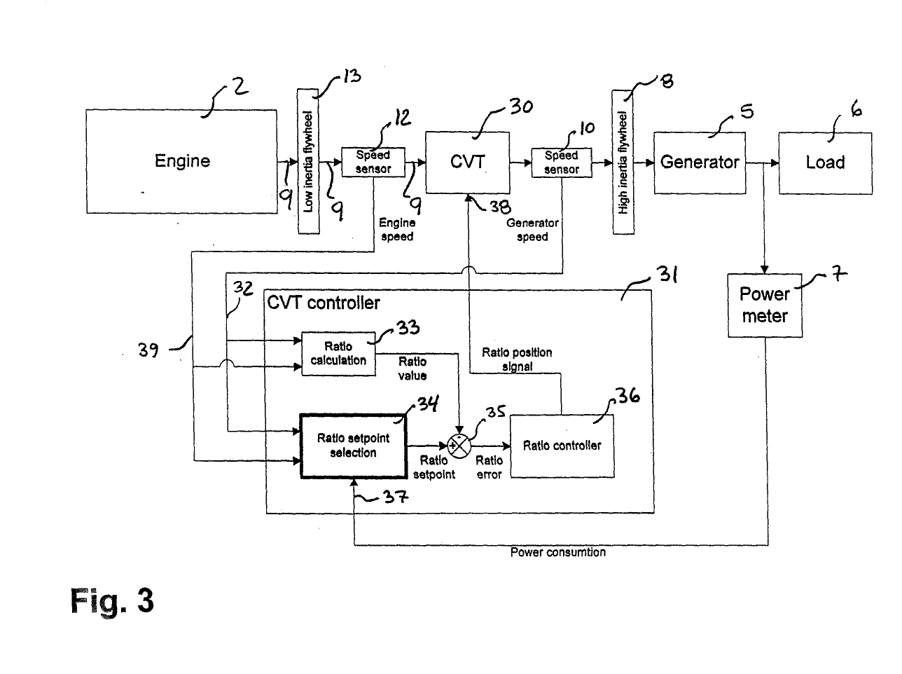

As seen from FIG. 3, where all engine control devices have been removed for more clarity, the CVT controller 31 is comprised of two main devices: the ratio control section comprising ratio controller 36, ratio monitoring device 33 and deviation evaluation device 35, and the ratio set point selection section represented by device 34. The ratio control section receives a ratio set point from ratio set point selection device 34, and compares it in deviation evaluation device 35 with the actual ratio value provided by the ratio monitoring (calculation) device 33 connected to the input speed sensor 12 and the output speed sensor 10. Obviously the actual ratio is obtained by dividing the output speed value by the input speed value. The actual ratio value is then subtracted from the ratio set point value in deviation evaluation device 35 to yield a deviation signal being sent to the ratio controller 36 which generates the appropriate ratio position signals to drive the actuators in the CVT device 30 to minimize the deviation with respect to the calculated ratio set point. Therefore, the ratio set point selection device 34 is the most critical section of the CVT controller, wherein the effective control of the engine 2 and the generator system 1 takes place for optimal system performance.

In order to optimize the engine speed, the ratio set point selection in device 34 must be performed in such a manner that for a given power demand from the generator 5, the CVT device will force the engine 2 to run at its most energy efficient speed. Moreover, upon changing power demand from the generator 5, the ratio set point must be adjusted so to minimize the amplitude of frequency and voltage transients in the output electrical wave produced by the generator 5 and supplied to the load 6. To that effect, the generator speed must remain as stable as possible. All of these challenges are faced by the control strategy implemented in the ratio set point selection device 34.

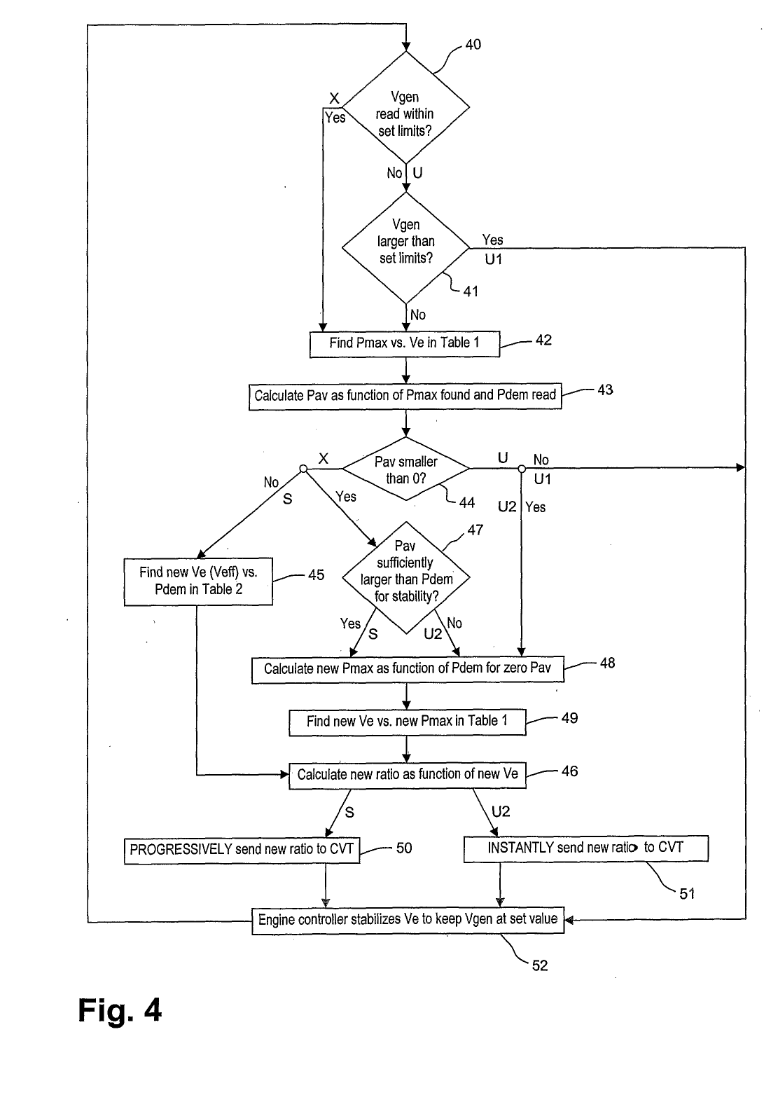

Referring to FIGS. 3 and 4, the control method implemented mostly in the ratio set point selection device 34 to achieve engine speed optimization and generator output linearity will now be described. The process chart of FIG. 4 represents an infinite loop accomplished many times a second by an electronic controller (e.g., a processor), such as a PID, in the ratio set point selection device 34. The process is as follows:

First, the speed sensor 10 reads the generator speed Vgen and communicates the generator speed Vgen to the ratio set point selection device 34 through a speed signal 32. Then, as shown in decision 40, the ratio set point selection device 34 compares the generator speed Vgen to a programmed acceptable range including a set point speed, e.g., 1500 r.p.m. or 1800 r.p.m. The set point speed is an operational value selected as a function of the desired output parameters. As described previously, the set point speed is, for instance, selected as a function of a desired frequency of the generator 5. Accordingly, the sensor 10 can send a frequency signal to the ratio set point selection device 34, which is compared to a frequency range including a set point, e.g., 50 Hz or 60 Hz.

If the generator speed Vgen is within the acceptable range (i.e., set limits), the stability level of the system is unknown at this point (case X), and the ratio set point selection device 34 proceeds to step 42. If the generator speed Vgen is out of the programmed range or set limits, the system is deemed unstable (case U) and the ratio set point selection device 34 proceeds to decision 41.

As indicated in decision 41, if the generator speed Vgen is out of the programmed range or set limits (case U), the ratio set point selection device 34 determines if the speed signal 32 is lower or higher than the set limits. If the speed signal 32 is higher than the set limits, than the CVT controller 31 does not need to intervene even though the system is unstable (case or category U1); the engine controller 4 (see FIG. 2) will react by reducing and stabilizing the speed Ve of the engine 2 until the generator speed Vgen reaches the set point, as shown in step 52, and the ratio set point selection device 34 restarts the loop at step 40.

If at step 41 the ratio set point selection device 34 determines that the generator speed Vgen is lower than the set limits, or if at step 40 the ratio set point selection device 34 determines that the generator speed Vgen is within the set limits, the power meter 7 communicates the power demand Pdem to the ratio set point selection device 34 through a power consumption signal 37, and the speed sensor 12 communicates the speed of the engine Ve to the ratio set point selection device 34 through a speed signal 39.

The ratio set point selection device 34 is provided with a database and, according to step 42, accesses a first programmed data table from the database to extract a value for a maximum engine power Pmax corresponding to the engine speed Ve. Then, as shown in step 43, the ratio set point selection device 34 calculates available power Pav based on the maximum engine power Pmax for the engine speed Ve and the power demand Pdem.

In a preferred embodiment, the available power Pav corresponds to the maximum engine power Pmax minus the power demand Pdem minus a safety factor providing some power reserve to sustain eventual sudden increases in power demand Pdem from the generator 5.

Then, as shown in step 44, the ratio set point selection device 34 evaluates if the available power Pav is lower than a first threshold. A preferred value for the first threshold is 0, such that only the power needed to sustain a sudden increase in power demand Pdem is available, i.e. the safety factor.

In the case where the generator speed Vgen is within the set limits (case X) and the available power is evaluated at decision 44 to be equal to or above the first threshold (e.g., 0), the system is stable (case or category S), whereby the available power Pav is sufficient, and the system may enter an energy-efficient, or economy, mode at step 45.

In step 45, the ratio set point selection device 34 accesses a second programmed data table of the database to extract an optimal engine speed Veff corresponding to the power demand Pdem. The optimal engine speed Veff provided by the second data table is the speed at which the engine 2 should be driven in order to be as efficient as possible for a given power demand Pdem of the generator 5. Preferably, the optimal engine speed Veff represents a compromise between the best efficiency speed value and a minimal value for being able to maintain the generator 5 in stable conditions (i.e. constant speed Vgen) in case of a sudden increase in power demand Pdem, e.g., 100% of the system's rated capacity.

As a practical example, if the power demand Pdem is 0 (i.e., no load), energy concerns would suggest bringing the engine speed Ve to its lower idle level, e.g., approx. 500 r.p.m., in view of the operating range of the transmission 30. However, with the engine speed Ve at idle level, if a full load were to be suddenly applied, the engine 2 would not be able to rise its speed Ve fast enough to maintain the generator speed Vgen within the set limits. For that reason, in programming the second data table, the optimal engine speed Veff for a power demand of 0 could be, for example, 1000 r.p.m. such that the engine 2 is able to react to a sudden load adequately, minimizing a duration and intensity of a transient response. Thus, the optimal engine speed Veff obtained from the second data table is the speed Ve at which the system should be operated for optimal efficiency and functionality at a given power demand Pdem. The second data table may be programmed taking into consideration the expected behavior of the load 6.

Then, according to step 46, the ratio set point selection device 34 calculates a new transmission ratio which will correspond to the ratio between the optimal engine speed Veff found in the second data table and the generator speed Vgen at the set value. The ratio set point selection device 34 sends the new transmission ratio to the deviation evaluation device 35.

The deviation evaluation device 35 also receives the actual transmission ratio from the ratio calculation device 33, calculated from the engine speed signal 39 provided by the sensor 13 and the generator speed signal 32 provided by the sensor 10.

As shown in step 50, since the system is stable, the ratio set point selection device 34 instructs the ratio controller 36 through the deviation evaluation device 35 to slowly correct the transmission ratio. The ratio controller 36 thus sends a ratio correction signal 38 to the CVT transmission 30, causing the transmission ratio to progressively reach the new transmission ratio calculated by the ratio set point selection device 34. The ratio correction is thus performed slowly, i.e. incrementally at each execution of the loop, so as to maintain stability and let the engine controller 4 adjust the engine speed Vgen following transmission ratio changes, as shown in step 52. Then, the ratio set point selection device 34 restarts the loop at decision 40.

As indicated in decision 47, in the case where the generator speed Vgen is within the set limits (case X) and the available power is evaluated in decision 44 to be lower than the first threshold, e.g., 0, the ratio set point selection device 34 compares the maximum engine power Pmax found in the first data table to the power demand Pdem, to determine if the maximum power Pmax is sufficiently larger than the power demand Pdem for the system to be stable even if the available power Pav is lower than the first threshold. In other words, the ratio set point selection device 34 determines if the system has an adequate safety margin, or safety factor, allowing the engine 2 to adequately compensate in case of a sudden load increase of the generator 5, with a minimal transitory period. This can be done, for example, by comparing the available power Pav (which is a function of the maximum engine power Pmax and the power demand Pdem) to a second threshold lower than the first threshold, the second threshold representing the chosen safety factor.

If at decision 47 the available power Pav is at least equal to the second threshold, i.e. the maximum engine power Pmax is sufficiently larger than the power demand Pdem, the system is stable (case S). As seen in step 48, the ratio set point selection device 34 calculates a new value for the maximum engine power Pmax, based on the power demand Pdem, which would produce an available power Pav at least equal to the first threshold (e.g., 0).

Then, as shown in step 49, the ratio set point selection device 34 accesses the first data table of the database to extract the value of the new engine speed Ve corresponding to this new value for the maximum engine power Pmax. This new engine speed Ve will enable the engine 2 to have the safety margin or factor allowing adequate compensation in case of a sudden load increase of the generator 5 with a minimal transitory period.

The previously described steps 46, 50 and 52 are then performed, that is, the ratio set point selection device 34 calculates a new transmission ratio corresponding to the new engine speed Ve found (step 46), sends the new transmission ratio to the ratio controller 36 which sends a ratio correction signal 38 to the CVT transmission 30 causing the transmission ratio to progressively reach the new transmission ratio (step 50), and the engine controller 4 adjusts the engine speed Ve following transmission ratio changes to maintain Vgen at the set value (step 52). The ratio set point selection device 34 then restarts the loop at step 40.

On the other hand, if at decision 47 the available power Pav is determined to be lower than the second threshold, i.e. the maximum engine power Pmax is not sufficiently larger than the power demand Pdem as determined by the ratio set point selection device 34, the system is anticipated to become unstable (case U2) Thus, the engine speed Ve must be increased rapidly in order to bring the system back in stable mode as soon as possible. The first steps performed are the same as when the available power Pav is at least equal to the second threshold, i.e. the ratio set point selection device 34 calculates a new value for the maximum engine power Pmax which would produce an available power Pav at least equal to the first threshold (step 48), extracts the corresponding new engine speed Ve value from the first data table (step 49), and calculates a new transmission ratio corresponding to the new engine speed Ve found (step 46).

However, as shown in step 51, since the system is unstable (case U2), the ratio set point selection device 34 instructs the ratio controller 36 to immediately correct the transmission ratio, and the ratio controller 36 sends a ratio correction signal 38 to the CVT transmission 30 causing the transmission ratio to immediately be changed to the new transmission ratio.

This is where the energy stored in high inertia output flywheel 8 is useful, being partly delivered to the system, to assist engine acceleration. As a consequence, the speed of the flywheel 8 is reduced and the generator speed Vgen is decreased following that of the output drive shaft 11 on which the flywheel 8 is mounted. The speed reduction at drive shaft 11 is detected by the engine controller 4 which reacts and turns the engine 2 to full throttle mode. Thus, the system can rapidly recover from a transitory lack of power and be maintained as stable as possible. The ratio set point selection device 34 then restarts the loop at step 40.

Similarly, if in the case where the generator speed Vgen is below the set range (case U), it is determined at decision 44 that the available power Pav is lower than the first threshold, the system is unstable (case or category U2). Accordingly, the steps performed are the same as the steps described above for the case where the generator speed Vgen is within the set range (case X) and at decision 47 it is determined that the available power Pav is below the second threshold. In other words, the ratio set point selection device 34 calculates a desired value for the maximum engine power Pmax which would produce an available power Pav at least equal to the first threshold (step 48), extracts the corresponding new engine speed Ve value from the first data table (step 49), calculates a new transmission ratio corresponding to the new engine speed Ve found (step 46), and instructs the ratio controller 36, which instructs the CVT transmission 30, to immediately change the actual transmission ratio for the new transmission ratio (step 51), taking advantage of the energy stored in high inertia output flywheel 8. The engine controller 4 reacts and increases the engine speed Ve to stabilize the generator speed (52), and the ratio set point selection device 34 restarts the loop at step 40.

Finally, if in the case where the generator speed Vgen is below the set range (case U), it is determined at decision 44 that the available power Pav is at least equal to the first threshold, the system is unstable but the CVT controller 31 does not need to intervene (case U1). The engine controller 4 uses the available power Pav to correct the engine speed Ve in order to stabilize the generator speed Vgen to the set value (step 52), and the ratio set point selection device 34 restarts the loop at step 40.

This completes the description of the control method implemented in the ratio set point selection device. In summary, in the system 1, the CVT controller 31 evaluates the stability level of the system based on the generator speed Vgen and the available power Pav, and classifies the system in one of three categories: a stable system (S), an unstable system that can be stabilized by the engine controller 23 alone (U1), or an unstable system that needs to be stabilized by the CVT controller 31 (U2). The controller 31 also evaluates a rate of transmission ratio change appropriate based on the stability level: if the system is stable, the ratio is changed progressively (e.g. incrementally), and if the system is unstable, the ratio is changed rapidly (e.g. instantaneously). Thus, the CVT controller 31 forces the engine 2 to progressively adopt speeds at which it is most efficient when the system is considered stable (S), and to rapidly adopt speeds at which it is the most powerful in transitory, or unstable, mode (U2). This performs a rough speed control leaving to the engine speed controller 4 perform a fine control, by adjusting combustion parameters, to stabilize the speed at the output of the engine/CVT tandem, to ensure that the generator frequency or speed is as stable as possible, and the supplied electrical wave meets the standards.

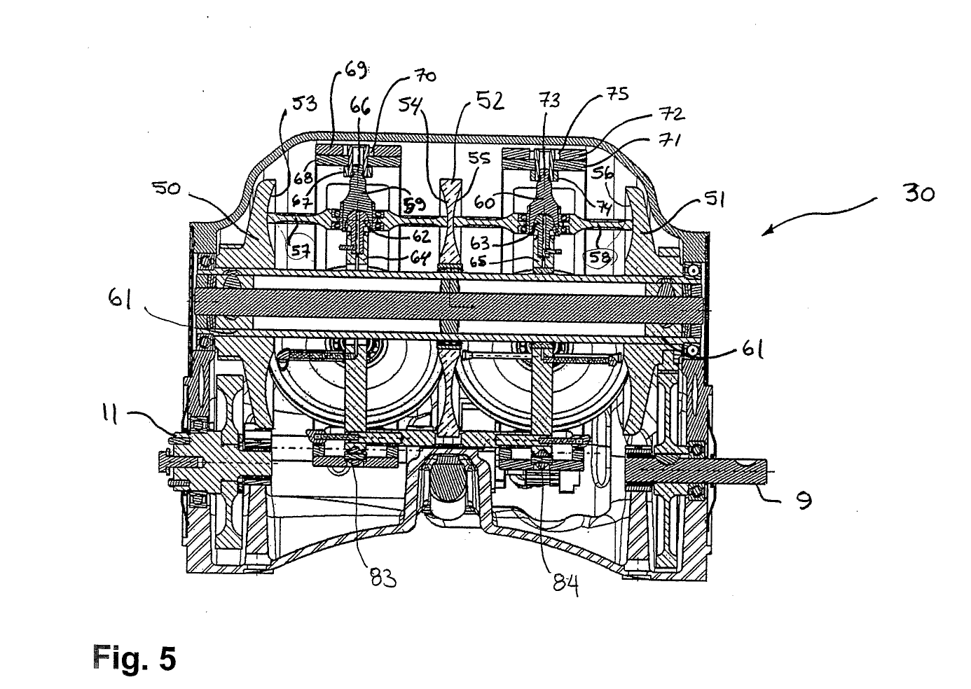

Turning now to FIG. 5, the CVT device 30, responsible for changing the ratios as directed by the set point selection device 34 and the ratio controller 36 will now be described in more detail.

The CVT device 30 is preferably a dual stage toroidal cavity roller-type continuously variable ratio transmission. In many aspects, the transmission is comparable to those of the prior art, and one may refer to U.S. Pat. No. 3,581,587 (Dickenbrock—Jun. 1, 1971—General Motors Corp.) or CA patent application No. 2,401,474 (Careau et al.—published Mar. 5, 2004—assigned to École de Technologie Supérieure) for a detailed description of its basic operation. Nevertheless, some significant improvements are contemplated in the present invention to provide an easily controllable roughed device for use in industrial applications such as electrical power generation. This type of transmission is preferred over other types such as hydrostatic CVT's since no hydraulics is required for its operation, which reduces both costs and maintenance. Moreover, toroidal transmissions usually have a significantly higher efficiency when compared to hydrostatic transmissions.

Generally stated, the transmission comprises a pair of outer input toroidal disks 50 and 51 fixedly mounted on rotary axle 61 and driven through input shaft 9 which is driven by the engine 2, and an inner double sided output toroidal disk 52 rotatably mounted about axle 61 and driving output shaft 11 through an output gear stage, thus driving the generator 5. Alternatively, the rotary axle 61 driving the outer toroidal disks 50,51 can be connected to the output shaft 11, thus driving the generator 5, and the inner toroidal disk 52 can be driven by the engine 2 through the input shaft 9.

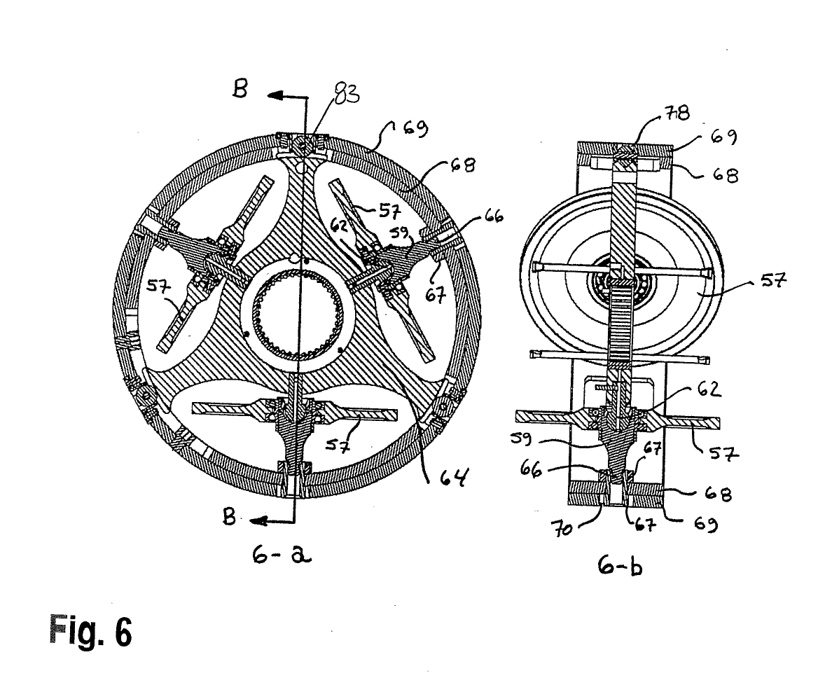

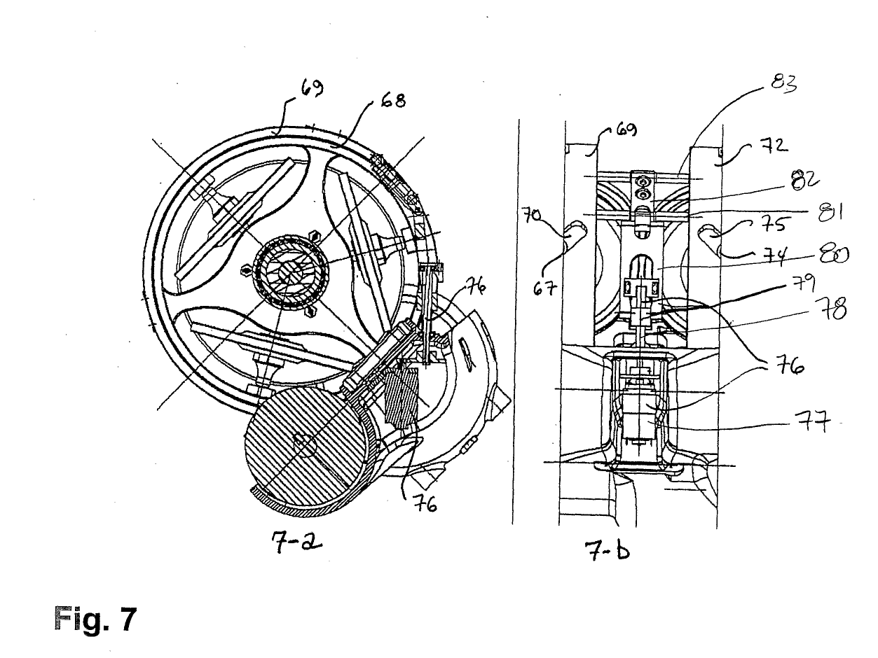

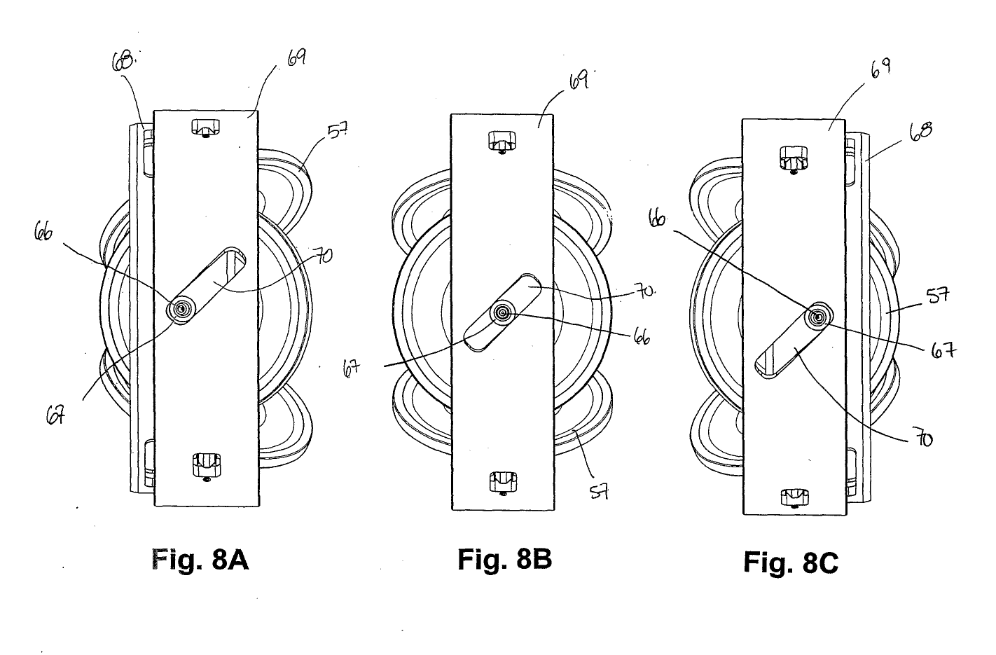

The toroidal disks 50,51,52 are provided with respective toroidal cavity races 53,54 and 55,56. Rotary power is symmetrically transferred from the outer input disks 50 and 51, connected through axle 61, to the inner output disk 52 through friction rollers such as 57 and 58, rotatably mounted on axially extending carriers 59,60 and running on and between two opposite races, transferring rotary power from one to the other (from outer races to inner races). A plurality of friction rollers 57,58, preferably three, are provided between each pair of races 53-54, 55-56, with their carriers 59,60 pivotally mounted on ball-shaped joints 62,63 extending from a common spider hub 64,65 rotatably mounted on axle 61 and fixedly connected to the transmission's housing. Alternatively two, four or even more rollers 57,58 can be provided between each pair of races 53-54 and 55-56. The distal ends 66,73 of the carriers 59,60 of a given set of rollers 57,58 are slidably assembled to a pair of coaxial circular rings, inner ring 68,71 and outer ring 69,72, also coaxial to axle 61 and mounted at the outer perimeter of the spider hub 64,65 (see FIG. 6a). The outer ring 69,72 is mounted on spider hub 64,65 through a series of rollers 83,84, one at the end of each arm of the spider hub 64,65, which enable a limited radial movement but prevent any axial movement of the outer ring 69,72 with respect to the fixed spider hub 64,65. Outer ring 69,72 is provided with three slots 70,75 (see particularly FIGS. 8a-8c) acting as guiding sleeves or cams for guiding the displacement of distal ends 66,73 of carriers 59,60 which are connected in three bushings 67,74 provided in the inner ring 68,71, each bushing 67,74 extending in a slot 70,75 from which a displacement force is transmitter thereto, and in turn to the distal ends 66,73. The inner ring 68,71 is thus connected to outer ring 69,72 and axially and radially movable with respect to said outer ring 69,72. The slots 70,75 and corresponding bushings 67,74 are provided 120 degrees apart over the circumference of the outer and inner rings 69,72; 68,71 respectively. FIGS. 6 and 7a-7b provide detailed radial cross-sectional views of the dual ring ratio control mechanism.

In operation, transmission ratio variations are carried-out by tilting the friction rollers 57,58 through displacement of the distal end 66,73 of the carriers 59,60 so that each roller 57,58 runs on a circular track of a different diameter on each opposite race 53-54 and 55-56. The ratio of the track diameters gives the transmission ratio for that given pair of disks, 50-52 and 51-52 (see FIGS. 8a-8c for different ratios). Displacement of the distal ends 66,73 is advantageously provided through a rotation of the outer ring 69,72 about axle 61, causing a radial force component on the inner ring 68,71 which holds the distal end 66,73 of the carriers 59,60. This rotation is thus causing the distal ends 66,73 to force a tilt of the carriers 59,60 about the ball shaped joint 62, 63. Thus the friction rollers 57,58 no longer run on a circular track but on a spiral track that, because of the opposite rotation of the pair of disks 50 (51) and 52, moves the roller's contact points up and down about the axle 61. The result of this movement of the frictions rollers 57,58 is a ratio change that force a rotation of the carriers 59,60 about the ball shaped joint 62,63. This rotation is now in a plane perpendicular to the prior tilt plane caused by the prior rotation of the outer ring 69,72, thus this rotation of the three carriers 59,60 of the same toroidal cavity moves the distal ends 66,73 and forces an axial movement of the inner ring 68,71. However, because the inner ring 68,71 can only move according to the three slots 70,75, this axial movement is also transferred to a rotational movement of the inner ring 68,71 about the axle 61 and in the opposite direction of the first outer ring's 69,72 rotation that initiated the ratio change. Once again, this rotation causes the distal ends 66,73 to force a tilt back of the carriers 59 about the ball shaped joint 62,63 and then the three friction rollers 57,58 of the same toroidal cavity no longer run on a spiral track but are back on a circular track and thus on a fixed ratio bringing the transmission back in steady state (see FIGS. 8a to 8c). An advantage of this arrangement is that all three rollers 57,58 of a trio are automatically moved in perfect synchronism and with high accuracy because the distal ends 66,73 of the carriers 59,60 are all linked in the precisely machined inner ring 68,71. The radial displacement of the outer rings 69,72 is advantageously accomplished using a single electrically driven linear actuator 76 such as a DC motor/endless-screw tandem, a solenoid or the like, which is a second advantage. Such an electrical device 76 can be easily controlled using the electrical signals generated by the ratio controller 36 of CVT controller 31.

As illustrated in FIG. 7, a single linear actuator 76 is advantageously used to simultaneously control the displacement of both outer rings 69, 72, and keep the ratio equal in both stages of the transmission 30. The actuator 76 comprises a DC geared motor 77 driving an endless screw 78 threadingly engaged in a nut 79. The nut 79 is connected to a first arm 80, which is connected through a first pin 81 to a second arm 82 at a first end thereof. The second arm 82 is connected at its second end to a second pin 83. Both the first and second pins 81,83 interconnect the two outer rings 69,72. Thus, upon reception of the ratio position signal 38 from the ratio controller 36 (see FIG. 3), the motor 77 rotates the endless screw 78, which in turn translates the nut 79, which produces a translation of the first and second arms 80,82 rotating the outer rings 69,72 through the first and second pins 81,83 in a coordinated manner. The actuator 76 allows for easy and coordinated control of the ratio in both stages of the transmission 30, as opposed to traditional CVT actuators which are usually hydraulically powered and as such less energy efficient, more costly and less durable.

In addition, the coordinated control of the ratio in both stages provided by the actuator 76 actuating together both outer rings 69,72, which are precisely machined and interconnected by pins 81,83, produces an improved ratio conformity between the stages which leads to an substantially high mechanical efficiency of the transmission 30.

One can thus easily appreciate that the above described embodiments according to the present invention provide a transmission system enabling constant speed drive of an apparatus from a variable speed mechanical energy source, and a high efficiency generator system featuring engine speed modulation which can be advantageously used to supply a variable load with stable electrical power and be advantageously used in miscellaneous filing applications.

The embodiments of the invention described above are intended to be exemplary. Those skilled in the art will therefore appreciate that the foregoing description is illustrative only, and that various alternatives and modifications can be devised without departing from the spirit of the present invention. The transmission 30 and controllers 23, 31 could be used to provide a constant speed input to various types of apparatus from a variable speed output produced by a various types of sources, or to provide a variable speed input to an apparatus from a constant speed output produced by a source. One example of the latter is having an electric motor producing a constant speed output and a conveyor receiving a variable speed input from the transmission. Accordingly, the present invention is intended to embrace all such alternatives, modifications and variances which fall within the scope of the appended claims.

1. A system for transmitting a variable output of a variable source of mechanical power into an input having a desired apparatus speed value for an apparatus, the system comprising:
a transmission receiving the variable output and producing the input, the transmission defining a transmission ratio between a first speed of the output and a second speed of the input;
a first sensor measuring the first speed and producing first speed data corresponding thereto;
a second sensor measuring the second speed and producing second speed data corresponding thereto;
a third sensor measuring a power demand of the apparatus and producing power demand data corresponding thereto;
a ratio set point controller receiving the first and second speed data and the power demand data, the ratio set point controller calculating an available power of the source and a stability level of the system as a function of the first speed data and the power demand data, determining a desired source speed value for the first speed as a function of the power demand, calculating a desired ratio value for the transmission ratio as a function of the desired source speed value, and determining a desired rate of change for the transmission ratio as a function of the stability level of the system;
a ratio controller interfacing the ratio set point controller to the transmission, the ratio controller actuating the transmission to change the transmission ratio to the desired ratio value following the desired rate of change; and
a source speed controller receiving the second speed data from the second sensor and changing the first speed until the second speed data corresponds to the desired apparatus speed value.

2. The system according to claim 1, wherein the ratio set point controller extracts from a maximum data table an actual maximum power value based on the first speed data, and calculates the available power based on the actual maximum power and the power demand data.

3. The system according to claim 2, wherein the ratio set point controller calculates a new maximum power higher than the actual maximum power and extracts the desired source speed value from the maximum data based on the new maximum power.

4. The system according to claim 1, wherein when for a given stability level and with the power demand data at least equal to a given threshold, the ratio set point controller extracts the desired source speed value from an efficiency data table based on the power demand data, the desired source speed value representing an energy efficient speed of the source corresponding to the power demand data.

5. The system according to claim 1, wherein the stability level of the system is evaluated by comparing the first speed data with a set range including the desired apparatus speed value and the power demand data with at least one threshold value.

6. A system for transforming a variable output of a variable source if mechanical power into an input having a desired speed value for an apparatus, the system comprising:
a transmission receiving the variable output and producing the input, the transmission having a variable ratio between a first speed of the output and a second speed of the input;
at least one sensor producing first speed data corresponding to the first speed, second speed data corresponding to a power demand of the apparatus;
a first controller receiving the first speed data, the second speed data and the power demand data, calculating an available power and a desired transmission ratio value based on the first speed data and the power demand data, classifying the system in one of at least first and second categories based on a first comparison of the first speed with a set range including the desired speed value and a second comparison of the available power with at least one threshold value, instructing the transmission to bring the variable ratio to the desired transmission ratio value rapidly when the system is in the first category, and instructing the transmission to bring the variable ratio to the desired transmission value progressively when the system is in the second category; and
a second controller receiving the second speed data and sending a speed correction signal to the source of mechanical power to change the first speed until the second speed data corresponds to the desired speed value.

7. The system according to claim 6, wherein the first controller classifies the system in one of the first category, the second category, and a third category based on the first and second comparisons, and the first controller refrains from instructing the transmission to change the variable ratio when the system is in the third category.

8. The system according to claim 7, wherein the first controller classifies the system in the third category when the first speed is higher than the set range.

9. The system according to claim 7, wherein the first controller classifies the system in the third category when the first speed is below the set range and the available power is higher than the at least one threshold value.

10. The system according to claim 6, wherein the first controller classifies the system in the first category when the first speed is below the set range and the available power is lower than the at least one threshold value.

11. The system according to claim 6, wherein the first controller classifies the system in the first category when the first speed is within the set range and the available power is lower than the at least one threshold value.

12. The system according to claim 6, wherein the at least one threshold value includes a first threshold value, and wherein the first controller classifies the system in the second category when the first speed is within the set range and the available power is higher than the first threshold value.

13. The system according to claim 12, wherein the at least one threshold value further includes a second threshold value higher than the first threshold value, and the first controller calculates an energy efficient value for the first speed based on the power demand data and calculates the desired transmission ratio value based on the energy efficient value for the first speed when the system is classified in the second category and the available power is higher than the second threshold value.

14. The system according to claim 6, wherein the first and second controllers operate independently.

15. The system according to any one of claims 1 or 6, wherein the transmission is a toroidal continuously variable transmission.

16. The system according to any one of claims 1 or 6, wherein the transmission includes a shaft producing the input and a high inertia flywheel mounted on the shaft.

17. The system according to any one of claims 1 or 6, wherein the source is an internal combustion engine and the apparatus is an electrical generator.

18. A method for controlling a variable transmission transforming a variable output of a variable source of mechanical power into an input having a desired speed value for an apparatus, the method comprising the steps of:
obtaining a first speed of the variable output, a second speed of the input, and a power demand of the apparatus;
calculating (1) an available power based on the first speed and the power demand, (2) a stability level of the input of the apparatus based on the first speed and the available power, (3) a desired ratio of the transmission based on the power demand, and (4) a desired rate of ratio change based on the stability level;
instructing the transmission to change to the desired ratio at the desired rate of ratio change; and
varying the first speed until the second speed is substantially equal to the desired speed value.

19. The method according to claim 18, further comprising:
calculating a desired maximum power value of the source based in the power demand, extracting a desired value for the first speed from a data table based on the desired maximum power value, and calculating the desired transmission value based on the desired value for the first speed.

20. The method according to claim 18, wherein at a given stability level and with the available power higher than a given threshold a desired value for the first speed is extracted from a data table based on the power demand, the desired value representing an energy efficient speed of the source while maintaining the available power at a desired level.

21. A toroidal transmission comprising:
first and second toroidal disks rotated by an input shaft;
a third toroidal disk located between the first and second toroidal disk and rotating an output shaft;
a plurality of first frictional rollers frictionally engaged to a toroidal cavity race of the first disk and a first toroidal cavity race of the third disk, each of the first frictional rollers being rotatable to transfer rotary power between the second and third disks;
a plurality of second frictional rollers frictionally engaged to a toroidal cavity race of the second disk and a second toroidal cavity race of the third disk, each of the second frictional rollers being rotatable to transfer rotary power between the first and third disks;
first means for retaining the first frictional rollers at a same first selective angle with respect to the third disk, the first means being actuable to change the first selective angle;
second means for retaining the second frictional rollers at a same second selective angle with respect to the third disk, the second means being actuable to change the second selective angle; and
third means for connecting the first and second means such that the first selective angle is substantially equal to the second selective angle and for actuating the first and second means together to obtain a selected value for the first and second selective angles, the selected value corresponding to at least one of a desired ratio of the transmission and a desired rate of ratio change of the transmission, the third means actuating the first and second means upon reception of a control signal.

22. A multi-stage continuously variable transmission, comprising:
a) a first transmission stage, including:
i) a first pair of races defining therebetween a first toroidal cavity;
ii) a first set of rollers in said first toroidal cavity to transfer rotary motion between said first pair of races;
b) a second transmission stage, including:
i) a second pair of races defining therebetween a second toroidal cavity;
iii) a second set of rollers in said second toroidal cavity to transfer rotary motion between said second pair of races;
c) a mechanical ratio control linkage interconnecting the rollers of said first set and of said second set, said mechanical ratio control linkage when displaced inducing a simultaneous change of the spatial position of the rollers of said first set and of said second set in said first and second toroidal cavities, respectively, thereby producing a coordinated transmission ratio change in said first and second stages.

23. A multi-stage continuously variable transmission as defined in claim 22, including an electric actuator to cause a displacement of said mechanical control linkage.

24. A multi-stage continuously variable transmission as defined in claim 23, wherein said electric actuator is responsive to an electric signal to cause the displacement of said mechanical ratio control linkage and produce a coordinated transmission ratio change in said first and second stages.

25. A multi-stage continuously variable transmission as defined in claim 24, wherein said electric actuator includes a linear actuator.

26. A multi-stage continuously variable transmission as defined in claim 23, wherein said electric linear actuator includes a motor driving an endless screw.

27. A multi-stage continuously variable transmission as defined in claim 24, wherein said first pair of races includes a first race and a second race opposite said first race, said second pair of races includes a third race and a fourth race opposite said third race, wherein said second race and said third race reside on opposite sides of a common rotatable disk structure.

28. A multi-stage continuously variable transmission as defined in claim 27, wherein said common rotatable disk structure is a first disk structure, said first race resides on a second rotatable disk structure distinct from said first disk structure and spaced apart from said first disk structure.

29. A multi-stage continuously variable transmission as defined in claim 28, wherein said fourth race resides on a third rotatable disk structure distinct from said first and second disk structures and spaced apart therefrom.

30. A multi-stage continuously variable transmission as defined in claim 29, wherein said first disk structure resides between said second and third disk structures.

31. A multi-stage continuously variable transmission as defined in claim 30, wherein said first, second and third disk structures are co-axial.

32. A multi-stage continuously variable transmission as defined in claim 31, wherein one of said first, second and third disk structures is/are coupled to an input shaft of said multi-stage continuously variable transmission.

33. A multi-stage continuously variable transmission as defined in claim 32, wherein the other of said first, second and third disk structures is/are coupled to an output shaft of said multi-stage continuously variable transmission.

34. A multi-stage continuously variable transmission as defined in claim 31, wherein each roller of said first set of rollers and of said second set of rollers is capable of tilting about an imaginary axis intercepting respective contact points between the roller and the pair of races in which the roller resides.

35. A multi-stage continuously variable transmission as defined in claim 34, wherein said mechanical ratio control linkage couples the rollers of said first set of rollers and of said second set of rollers, a displacement of said mechanical ratio control linkage causing the rollers of said first set of rollers and of said second set of rollers to tilt simultaneously about their respective imaginary axes.

36. A multi-stage continuously variable transmission as defined in claim 35, wherein each roller of said first set of rollers and of said second set of rollers is rotatably mounted on a carrier, said mechanical ratio control linkage causing said carrier to tilt for causing, in turn the roller to tilt about the imaginary axis.

37. A multi-stage continuously variable transmission as defined in claim 36, wherein said mechanical ratio control linkage includes a first segment coupled with said first set of rollers and a second segment coupled with said second pair of rollers.

38. A multi-stage continuously variable transmission as defined in claim 37, wherein said first segment and said second segment are angularly moveable with respect to a common axis of rotation of said first, second and third disk structures, in order to cause said rollers of said first and second sets to tilt about their respective imaginary axes.

39. A multi-stage continuously variable transmission as defined in claim 38, wherein said imaginary axis is a first imaginary axis, said first and second segments include a connection with each roller of said first and second sets to allow the roller to tilt about a second imaginary axis that is perpendicular to said first imaginary axis and that produces a ratio change.

40. A multi-stage continuously variable transmission as defined in claim 39, wherein said mechanical ratio control linkage includes a slot to control a tilting movement of at least one of said rollers, whereby when said at least one of said rollers tilts about said second imaginary axis said slot causes the roller to move such as to negate a tilt that the roller has previously acquired about said first imaginary axis.

41. A multi-stage continuously variable transmission, comprising:
a) a first transmission stage, including:
i) a first pair of races defining therebetween a first toroidal cavity;
ii) a first set of rollers in said first toroidal cavity to transfer rotary motion between said first pair of races;
b) a second transmission stage, including:
i) a second pair of races defining therebetween a second toroidal cavity;
iii) a second set of rollers in said second toroidal cavity to transfer rotary motion between said second pair of races
c) said first pair of races and said second pair of races being rotatable about a common axis;
d) a ratio control device angularly movable about said common axis to induce a simultaneous change of the spatial position of the rollers of said first set and of said second set in said first and second toroidal cavities, respectively, thereby producing a coordinated transmission ratio change in said first and second stages.

42. A multi-stage continuously variable transmission as defined in claim 41, wherein said ratio control device is a mechanical linkage.

43. A multi-stage continuously variable transmission as defined in claim 42, including an electric actuator to cause an angular movement of said mechanical linkage about said common axis.

44. A multi-stage continuously variable transmission as defined in claim 43, wherein said electric actuator is responsive to an electric signal to cause the angular movement of said mechanical linkage about said common axis and produce a coordinated transmission ratio change in said first and second stages.

45. A multi-stage continuously variable transmission as defined in claim 44, wherein said electric actuator includes a linear actuator.

46. A multi-stage continuously variable transmission as defined in claim 45, wherein said linear actuator includes an electric motor driving an endless screw.

47. A multi-stage continuously variable transmission as defined in claim 43, wherein said first pair of races includes a first race and a second race opposite said first race, said second pair of races includes a third race and a fourth race opposite said third race, wherein said second race and said third race reside on opposite sides of a common rotatable disk structure.

48. A multi-stage continuously variable transmission as defined in claim 47, wherein said common rotatable disk structure is a first disk structure, said first race resides on a second rotatable disk structure distinct from said first disk structure and spaced apart from said first disk structure.

49. A multi-stage continuously variable transmission as defined in claim 48, wherein said fourth race resides on a third rotatable disk structure distinct from said first and second disk structures and spaced apart therefrom.

50. A multi-stage continuously variable transmission as defined in claim 49, wherein said first disk structure resides between said second and third disk structures.

51. A multi-stage continuously variable transmission as defined in claim 50, wherein said first, second and third disk structures are co-axial.

52. A multi-stage continuously variable transmission as defined in claim 51, wherein one of said first, second and third disk structures is/are coupled to an input shaft of said multi-stage continuously variable transmission.

53. A multi-stage continuously variable transmission as defined in claim 52, wherein the other of said first, second and third disk structures is/are coupled to an output shaft of said multi-stage continuously variable transmission.

54. A multi-stage continuously variable transmission as defined in claim 51, wherein each roller of said first set of rollers and of said second set of rollers is capable of tilting about an imaginary axis intercepting respective contact points between the roller and the pair of races in which the roller resides.

55. A multi-stage continuously variable transmission as defined in claim 54, wherein said mechanical linkage couples the rollers of said first set of rollers and of said second set of rollers, a displacement of said mechanical linkage causing the rollers of said first set of rollers and of said second set of rollers to tilt simultaneously about their respective imaginary axes.

56. A multi-stage continuously variable transmission as defined in claim 55, wherein each roller of said first set of rollers and of said second set of rollers is rotatably mounted on a carrier, said mechanical ratio control linkage causing said carrier to tilt for causing, in turn the roller to tilt about the imaginary axis.

57. A multi-stage continuously variable transmission as defined in claim 56, wherein said mechanical linkage includes a first segment coupled with said first set of rollers and a second segment coupled with said second pair of rollers.

58. A continuously variable transmission, comprising:
a) a pair of races defining therebetween a toroidal cavity;
b) a set of rollers in said toroidal cavity to transfer rotary motion between said pair of races;
c) a support for supporting said set of rollers in said toroidal cavity, said rollers being mounted to said support via respective ball joints allowing each roller to:
i) tilt about a first imaginary axis that intersects respective points of contact of the roller with the respective races;
ii) tilt about a second imaginary axis that is perpendicular to said first imaginary axis and that produces a change in an angle between the roller and the respective races, thereby varying a ratio of the transmission.

59. A continuously variable transmission as defined in claim 58, including a mechanical ratio control linkage connecting with said rollers, said mechanical ratio control linkage when displaced inducing a simultaneous change of the spatial position of said rollers by moving said rollers on the respective ball joints, thereby producing a transmission ratio change.

60. A continuously variable transmission as defined in claim 59, including an electric actuator to cause the displacement of said mechanical control linkage.

61. A continuously variable transmission as defined in claim 60, wherein said electric actuator is responsive to an electric signal to cause the displacement of said mechanical ratio control linkage.

62. A continuously variable transmission as defined in claim 61, wherein said electric actuator includes a linear actuator.

63. A continuously variable transmission as defined in claim 62, wherein said linear actuator includes an electric motor driving an endless screw.

64. A continuously variable transmission as defined in claim 59, wherein said mechanical ratio control linkage includes a slot to control a tilting movement of at least one of said rollers, whereby when said at least one of said rollers tilts about said second imaginary axis said slot causes the roller to move such as to negate a tilt that the roller has previously acquired about said first imaginary axis.

65. A continuously variable transmission, comprising:
a) a pair of races defining therebetween a toroidal cavity;
b) a set of rollers in said toroidal cavity to transfer rotary motion between said pair of races;
c) a mounting structure for supporting said set of rollers in said toroidal cavity, said mounting structure allowing each roller to:
i) tilt about a first imaginary axis that intersects respective points of contact of the roller with the respective races;
ii) tilt about a second imaginary axis that is perpendicular to said first imaginary axis and that produces a change in an angle between the roller and the respective races, thereby varying a ratio of the transmission;
iii) lock the roller against a translational movement with respect to said pair of races.

66. A continuously variable transmission as defined in claim 65, including a mechanical ratio control linkage connecting with said rollers, said mechanical ratio control linkage when displaced inducing a simultaneous change of the spatial position of said rollers, thereby producing a transmission ratio change.

67. A continuously variable transmission as defined in claim 66, including an electric actuator to cause the displacement of said mechanical control linkage.

68. A continuously variable transmission as defined in claim 67, wherein said electric actuator is responsive to an electric signal to cause the displacement of said mechanical ratio control linkage.

69. A continuously variable transmission as defined in claim 68, wherein said electric actuator includes a linear actuator.

70. A continuously variable transmission as defined in claim 69, wherein said linear actuator includes an electric motor driving an endless screw.

71. A continuously variable transmission as defined in claim 66, wherein said mounting structure includes a support, said rollers being mounted to said support via respective ball joints.

72. A continuously variable transmission as defined in claim 71, wherein said mounting structure includes a plurality of carriers associated with respective rollers, each roller being rotatably mounted on a respective carrier, each carrier including an end portion mounted to said support via one of said ball joints.

73. A continuously variable transmission as defined in claim 66, wherein said mechanical ratio control linkage includes a slot to control a tilting movement of at least one of said rollers, whereby when said at least one of said rollers tilts about said second imaginary axis said slot causes the roller to move such as to negate a tilt that the roller has previously acquired about said first imaginary axis.

74. Electrical power generating arrangement, comprising:
a) a driveline including an electrical generator for use in supplying electrical power to a load, a continuously variable transmission and an internal combustion engine, wherein the internal combustion engine drives the electrical generator via the continuously variable transmission;
b) first and second flywheels in the driveline, the continuously variable transmission being mounted in the driveline between the first and second flywheels;
c) the first flywheel having a lower inertia than the second flywheel;
d) the first flywheel being upstream the second flywheel with relation to a power flow direction in the driveline from the internal combustion engine to the electrical generator.

75. Electrical power generating arrangement as defined in claim 74, wherein the continuously variable transmission is a toroidal transmission.

76. Electrical power generating arrangement as defined in claim 74, including an electronic control to regulate a ratio of the continuously variable transmission.

77. Electrical power generating arrangement as defined in claim 76, wherein the electronic control regulates a power output of the internal combustion engine.

78. Electrical power generating arrangement as defined in claim 77, wherein the electronic control regulates the ratio of the continuously variable transmission and the power output of the internal combustion engine to maintain the speed at which the electrical generator turns substantially constant.

79. Electrical power generating arrangement as defined in claim 76, wherein the continuously variable transmission includes a mechanical control linkage to produce a ratio change of the continuously variable transmission and an electric actuator for causing displacement of the mechanical control linkage to produce the ratio change.

80. Electrical power generating arrangement as defined in claim 79, wherein the electric actuator is responsive to a control signal output from the electronic control to cause displacement of the mechanical control linkage.

81. Electrical power generating arrangement, comprising:
a) a driveline including an electrical generator for use in supplying electrical power to a load, a continuously variable transmission that has a variable ratio and an internal combustion engine, wherein the internal combustion engine drives the electrical generator via the continuously variable transmission;
b) an electronic control for directing the continuously variable transmission to vary its ratio, the electronic control including logic that selects a rate at which the ratio of the continuously variable transmission is to be progressively varied, wherein in use the ratio of the continuously variable transmission can be varied at different rates.

82. Electrical power generating arrangement as defined in claim 81, wherein the logic selects the rate at which the ratio of the continuously variable transmission is to be varied by using as a factor one or more operating conditions of the electrical power generating arrangement.

83. Electrical power generating arrangement as defined in claim 82, wherein one operating condition that is used as a factor by the selection logic is the stability of the electrical power generating arrangement.

84. Electrical power generating arrangement as defined in claim 83, wherein said electrical power generating arrangement can acquire either one of a stable operational condition and an unstable operational condition, when the electrical power generating arrangement is in an unstable operating condition the logic directing the continuously variable transmission to change the ratio faster than if the electrical power generating arrangement is in a stable condition.

85. Electrical power generating arrangement as defined in claim 84, wherein the continuously variable transmission is a toroidal transmission and said electronic control controlling a ratio of the toroidal transmission and a power output of the internal combustion engine to vary the mechanical power input into the electric generator according to variations of the electrical power demanded by the load, while maintaining the rotational speed of the electrical generator substantially constant.

86. Electrical power generating arrangement, comprising:
a) a driveline including an electrical generator for use in supplying electrical power to a load, a continuously variable transmission that has a variable ratio and an internal combustion engine, wherein the internal combustion engine drives the electrical generator via the continuously variable transmission;
b) an electronic control for directing the continuously variable transmission to vary its ratio at a rate that is dependent on the rate at which the electrical power demand of the load varies.

87. Electrical power generating arrangement, comprising:
a) a driveline including an electrical generator for use in supplying electrical power to a load, a continuously variable transmission that has a variable ratio and an internal combustion engine, wherein the internal combustion engine drives the electrical generator via the continuously variable transmission;
b) an electronic control for directing the continuously variable transmission to vary its ratio, the electronic control including logic selects a rate at which the ratio of the continuously variable transmission is to be progressively varied among a range of rates.

88. Electrical power generating arrangement, comprising:
a) a driveline including an electrical generator for use in supplying electrical power to a load, a continuously variable transmission that has a variable ratio and an internal combustion engine, wherein the internal combustion engine drives the electrical generator via the continuously variable transmission;
b) an electronic control for directing the continuously variable transmission to vary its ratio, the electronic control including logic to determine a target ratio that the continuously variable transmission is to acquire, the electronic control sending control signals to the continuously variable transmission to progressively change its ratio from a current ratio to the target ratio at a rate at which the ratio of the continuously variable transmission is to be progressively varied, wherein in use the ratio of the continuously variable transmission can be varied at different rates.
